(19) United States
(12) Patent Application Publication
(10) Pub. No.: US 2002/0095656 A1
(43) Pub. Date: Jul. 18, 2002

(54) Extensible software development using asynchronous messaging

(76) Inventors: Lori Clark, Sandy, UT (US); Harold Weir, Lindon, UT (US); Derek Jones, Pleasant Grove, UT (US); Garrette Pease, Riverton, UT (US); David Carpenter, Salt Lake City, UT (US)

Correspondence Address: Kevin K. Johanson, WORKMAN, NYDEGGER & SEELEY, 1000 Eagle Gate Tower, 60 East South Temple, Salt Lake City, UT, 84111, US

(21) Appl. No.: 09/952,585

(22) Filed: Sep. 14, 2001

Related U.S. Application Data
(60) Provisional application No. 60/233,070, filed on Sep. 15, 2000.

(51) Int. Cl. G06F 9/44; G06F 9/00

(52) U.S. Cl. 717/107; 717/110; 709/313; 709/316

(57) ABSTRACT

A method and computer software architecture is presented for facilitating modification of execution of a software application without impacting the integrity of the original software. The present invention defines an inter-component messaging service which brokers or receives, evaluates and directs messages between components of the architecture. The architecture further integrates functionality into the individual components which re-directs a request back to the messaging service prior to completion of the functionality in the requested original component in order to determine the presence of any concerned extension components that have registered with the messaging service thereby making known their interest in having their functionality explored prior to completion of the execution of the requested component.

### CROSS-REFERENCE TO RELATED APPLICATIONS

The present application claims priority from and is a continuation-in-part of U.S. Provisional Patent Application No. 60/233,070, entitled EXTENSIBLE DEVELOPMENT PLATFORM, which was filed on Sep. 15, 2000, and is hereby incorporated by reference in its entirety. Additionally, the present application is related to and includes the disclosure of Assignee's co-pending U.S. Patent Application Serial No. ______, entitled CONSTRUCTION OF VIRTUAL OBJECTS BASED ON RUN-TIME TYPE INFORMATION (Attorney Docket No. 15016.31), which is hereby incorporated by reference in its entirety; and Assignee's co-pending U.S. Patent Application Serial No. ______ , entitled EXTENDED ASYNCHRONOUS MESSAGING (Attorney Docket No. 15016.33), which is hereby incorporated by reference in its entirety.

### BACKGROUND OF THE INVENTION

1. The Field of the Invention

This invention generally relates to computing systems, and more particularly to a system and method for providing extensibility for customization of standard software applications.

2. The Relevant Technology

Early development of software applications retained a simplistic tone and moderate complexity. Those applications were generally independent and self-contained and were often written by a relatively few number of programmers. Such applications also tended to be economical to develop as they generally performed specific tasks on specific data.

As software applications became more complex, development of custom applications for each individual system became impractical both because of the associated expenses with generating lengthy sophisticated software, as well as the lengthy design/development cycle. Presently, development of custom applications involves extensive testing and quality assurance measures due to the associated complexities and interoperability concerns between independently developed software components. Any modifications to the tested and qualified software components/applications requires retesting and requalification to reverify interoperability within and among various components and applications.

Such unfavorable prospects with regard to software modifications of existing components/applications offers a business few alternatives. Businesses and enterprises are forced to decide between developing custom software or extensively modifying existing software to better fit their needs, certainly at great expense and time delay, or, alternatively and usually much less favorable, altering their business application needs to conform with one-size-fits-all standard software applications.

Furthermore, as businesses seek to hone their competitive edge, they are open to integration of existing software applications that would improve their efficiencies by automation and integration. However, these same businesses may have software components/applications in use that either service specific aspects of their business in a generally acceptable manner or cannot be prematurely retired because of the incurred cost of custom development.

It would be and advancement to provide an extensible software architecture that could accommodate customization and tailoring of software applications without impacting the established base application including components that have already been evaluated and qualified.

### BRIEF SUMMARY OF THE INVENTION

A method and computer software architecture is presented for facilitating modification of execution of a software application without impacting the integrity of the original software. The present invention defines an inter-component messaging service which brokers or receives, evaluates and directs messages between components of the architecture. The architecture further integrates functionality into the individual components which re-directs a request back to the messaging service prior to completion of the functionality in the requested original component in order to determine the presence of any concerned extension components that have registered with the messaging service thereby making known their interest in having their functionality explored prior to completion of the execution of the requested component.

More extensively, in the extensible software approach of the present invention, an inter-component messaging service receives a message having a processing request therein from a request-initiating component. The messaging service determines which component in the original software application is to be the recipient or is the owner of the request. The messaging service forwards the request to the identified original component for processing.

During processing of the request by the identified original component, the original component defers completion of the processing and generates a check request to the messaging service. The check request invites any extension components which have been subsequently added to the original software application and that have indicated a vested interest in the processing, otherwise performed by the original component, to additionally perform their functionality if they have registered with the messaging service.

The registered extension component, upon completion of any processing, replies back to the messaging service with, in the preferred embodiment, a status as to whether the evaluations performed by the extension component allow the original component to complete the request processing. The messaging service forwards the reply back to the original request processing component which evaluates the status or reply generated by the extension component and proceeds accordingly in response to the reply status.

The original component returns a request completion message with any data to the messaging service for further routing to either additional extension components registered as interested listeners to the now-generated request completion message or to the request-initiating component. It should be appreciated that these steps of nesting additional extension components within extension components as well as multiple check request points within the original component structure are contemplated within the present invention.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a typical computer environment within which the present invention maybe practiced;

FIG. 2 illustrates a block diagram of a computing environment including exemplary components of a software application, in accordance with a preferred embodiment of the present invention;

FIG. 3 illustrates a functional block diagram of the various interactive components of the present invention, in accordance with a preferred embodiment;

FIG. 4 illustrates a flow diagram of the various components interacting with the messaging service, in accordance with a preferred embodiment of the present invention;

FIG. 5 is a flow diagram illustrating one example of the extensible architecture of the present wherein the illustrated extension components returns responses allowing the original request processing component to continue processing, in accordance with a preferred embodiment of the present invention;

FIG. 6 is a flow diagram illustrating another example of the extensible architecture of the present invention wherein the illustrated extension components return varied responses in accordance with a preferred embodiment of the present invention; and same as 6 but “yet another example.

FIG. 7 illustrates a variety of status responses from the extension components in accordance with the preferred embodiment with the present invention.

### DETAILED DESCRIPTION OF THE PREFERRED EMBODIMENTS

The present invention extends to both methods and systems for creating an extensible computer software application that facilitates customization of the software without modifying the original software components. The embodiments of the present invention may comprise a special purpose or general-purpose computer including various computer hardware, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

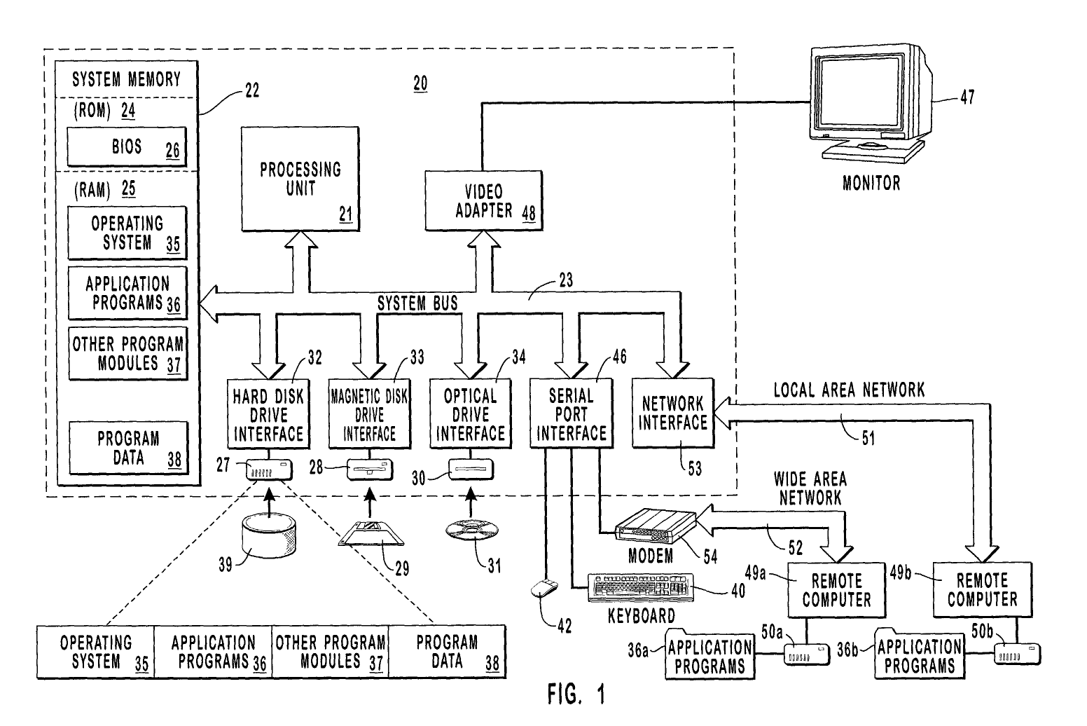

FIG. 1 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 1, an exemplary system for implementing the invention includes a general purpose computing device in the form of a conventional computer 20, including a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help transfer information between elements within the computer 20, such as during start-up, may be stored in ROM 24.

The computer 20 may also include a magnetic hard disk drive 27 for reading from and writing to a magnetic hard disk 39, a magnetic disk drive 28 for reading from or writing to a removable magnetic disk 29, and an optical disk drive 30 for reading from or writing to removable optical disk 31 such as a CD-ROM or other optical media. The magnetic hard disk drive 27, magnetic disk drive 28, and optical disk drive 30 are connected to the system bus 23 by a hard disk drive interface 32, a magnetic disk drive-interface 33, and an optical drive interface 34, respectively. The drives and their associated computer-readable media provide nonvolatile storage of computer-executable instructions, data structures, program modules and other data for the computer 20. Although the exemplary environment described herein employs a magnetic hard disk 39, a removable magnetic disk 29 and a removable optical disk 31, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 39, magnetic disk 29, optical disk 31, ROM 24 or RAM 25, including an operating system 35, one or more application programs 36, other program modules 37, and program data 38. A user may enter commands and information into the computer 20 through keyboard 40, pointing device 42, or other input devices (not shown), such as a microphone, joy stick, game pad, satellite dish, scanner, or the like. These and other input devices are often connected to the processing unit 21 through a serial port interface 46 coupled to system bus 23. Alternatively, the input devices may be connected by other interfaces, such as a parallel port, a game port or a universal serial bus (USB). A monitor 47 or another display device is also connected to system bus 23 via an interface, such as video adapter 48. In addition to the monitor, personal computers typically include other peripheral output devices (not shown), such as speakers and printers.

The computer 20 may operate in a networked environment using logical connections to one or more remote computers, such as remote computers 49a and 49b. Remote computers 49a and 49b may each be another personal computer, a server, a router, a network PC, a peer device or other common network node, and typically include many or all of the elements described above relative to the computer 20, although only memory storage devices 50a and 50b and their associated application programs 36a and 36b have been illustrated in FIG. 1. The logical connections depicted in FIG. 1 include a local area network (LAN) 51 and a wide area network (WAN) 52 that are presented here by way of example and not limitation. Such networking environments are commonplace in office-wide or enterprise-wide computer networks, intranets and the Internet.

When used in a LAN networking environment, the computer 20 is connected to the local network 51 through a network interface or adapter 53. When used in a WAN networking environment, the computer 20 may include a modem 54, a wireless link, or other means for establishing communications over the wide area network 52, such as the Internet. The modem 54, which may be internal or external, is connected to the system bus 23 via the serial port interface 46. In a networked environment, program modules depicted relative to the computer 20, or portions thereof, may be stored in the remote memory storage device. It will be appreciated that the network connections shown are exemplary and other means of establishing communications over wide area network 52 may be used.

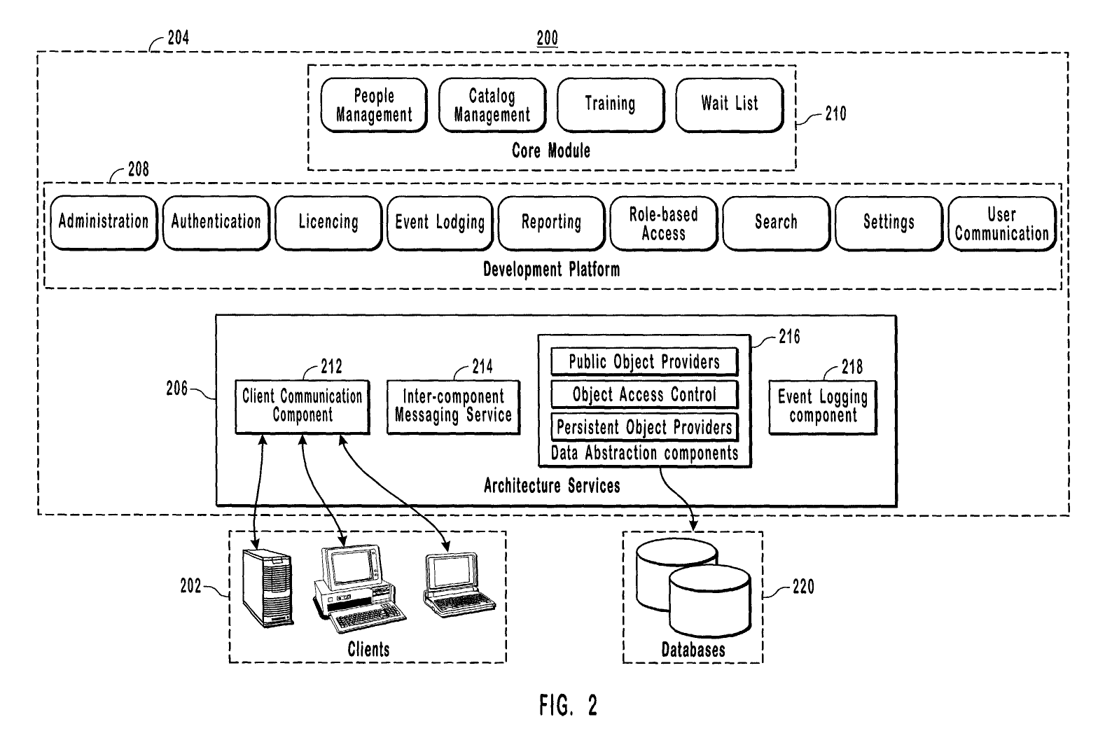

FIG. 2 illustrates a component and hardware diagram of an exemplary application incorporating the inventive software extension system, in accordance with a preferred embodiment of the present invention. FIG. 2 illustrates an application system 200, which is comprised of various layers of components. For illustrative purposes, the present example incorporates various levels of abstraction to facilitate software development in accordance with design principles.

In FIG. 2, application system 200 is comprised of hardware components 202 which interface with the software application 204, which for illustrative purposes is comprised of software modules including architecture services 206, a development platform 208 and a core modules 210. In the present example, core modules 210 illustrates an exemplary educational application comprised of educational components but may be comprised of any other types of components including accounting components, transactional components, as well as any other components which perform the desired functionality of the over all software application, and as such is to be considered illustrative and not limiting. Architecture services 206 interact with hardware components 202 through a client communication component 212 which performs general I/O services with the clients.

Architecture services 206 further include an inter-component messaging service 214 for implementing a brokering interface between the various components of the software application. The present invention facilitates the delivery of asynchronous messages to all original components and to extension components that have registered with inter-component messaging service 214 as registered listeners of a message. Such registration and software execution modifications are detailed below. Architecture services 206 further include data abstraction components 216 which may perform various functions, known by those of skill in the art. By way of example, architecture services 206 may further include event-logging services 218, which may track an execution history of the interaction of the various components, described herein.

Software application 204 is further comprised of a development platform 208, which includes various components, the functionality of which is generally appreciated by those skilled in the art to be useful for the development and deployment of software application 204. Core module components 210 further provide tailoring of a software application into a specific type of application, which for exemplary purposes is depicted herein as an educational application. Additionally, in order for software application 204 to interact with specific user information, databases 220 provide data and data structures useful in performing the designed functionality of software application 204.

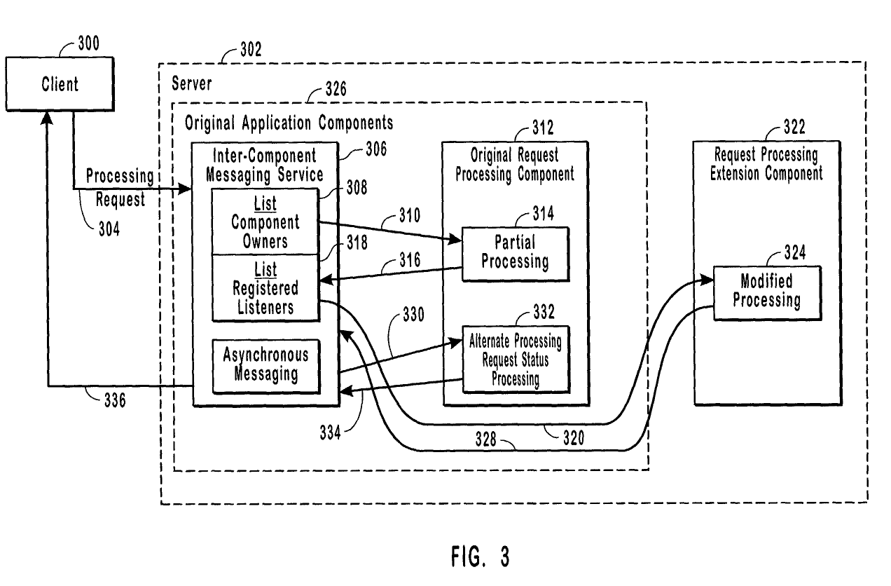

FIG. 3 illustrates a simplified component diagram of message flow between a messaging service and the other various components within the extensible software development and customization system of the present invention. The present invention provides a method and system for facilitating the extensibility of software without impacting the original application components of the underlining application software to be customized.

Generally, the extensibility functionality is accomplished by facilitating message exchange between software components through an inter-component messaging service. New or extension components register themselves with the messaging service as “concerned listeners” that are consulted by the related original components, via the messaging service, prior to the original components completing their component processing as a result of a received processing request.

In addition, a consistent method of sending messages, preferably asynchronous messages both before and after request processing, provides a standard method for allowing other components to extend and redirect the execution of the original application components. Such an approach facilitates customization of software applications as the execution and response of original processing components may be modified as a result of the presence and responses of the new extension components that are registered as listeners with the messaging service. Such a message-consulting approach allows the original application components to maintain their integrity and remain intact since modification to the overall execution of the application has not affected the integrity of the original components and therefore the associated quality and testing results associated with those original components.

Such an approach provides a means for supplanting the functionality of an entire original component without causing any disruption or changes to other components within the system. Furthermore, such an approach allows for source code integrity management since the original application components do not change when undergoing customization. Additional extension components may be added to the original application software without affecting the original code execution path of the original components nor the integrity of the original code. Such an approach lends itself to maintaining quality assurance processes, as the original code does not need to undergo re-verification or retesting. Therefore, the addition of an extension component which may undergo testing and evaluation, would not affect the verification and the full regression testing of the original components.

FIG. 3 depicts a client 300 interfacing with a server 302, in accordance with one implementation of the present invention. In the present figure, a client 300 issues a processing request 304 to an inter-component messaging service 306. Inter-component messaging service 306 consults a list or other database, depicted as list 308, to determine the owner or component to which the processing request is directed. Upon discernment of the appropriate component owner, inter-component messaging service 306 initiates an inter-component-messaging-service-to-component message 310, having the processing request therein, to the identified component owner, depicted herein as an original request-processing component 312.

Original request processing component 312, while containing the functionality for executing the requested process, has such functionality partitioned into a preliminary or partial processing module 314, which performs at least preliminary processing of the processing request and may, alternatively, include more extensive processing as a result of the processing request. Execution of partial processing module 314 generates a component-to-inter-component-messaging-service message 316 which includes a check processing request message. Inter-component-messaging-service 306 consults a list or other database entry to determine any and all registered listeners, also known as “extension components”, that have posted themselves with the messaging service 306 as an entity that is concerned or interested in the particular processing request. Upon identification of the registered listeners from, for example, a list 318, inter-component messaging service 306 generates an inter-component-messaging-service-to-component message 320, having the check-processing request therein, to each of the identified listeners depicted as request processing extension component 322.

Request processing extension component 322 is comprised of the modified processing module 324 that is external to the original application components 326 and therefore any modified processing taking place therein does not affect the integrity of original application components 326. Modified processing module 324, in response to the check processing request, performs the modified processing module steps and generates in a component-to-inter-component-messaging-service message 328 as a reply from the request processing extension component 322. This reply is then forwarded by inter-component messaging service 306 to original request processing component 312 in an inter-component-messaging-service-to-component message 330, which is received, by original request processing component 312.

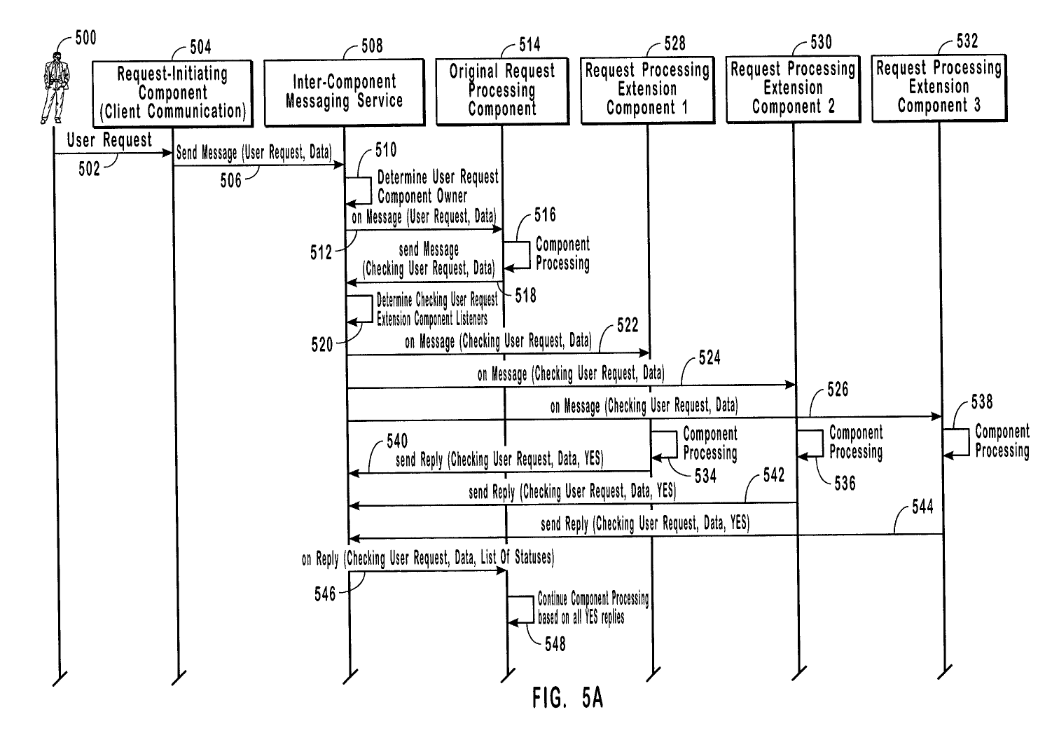

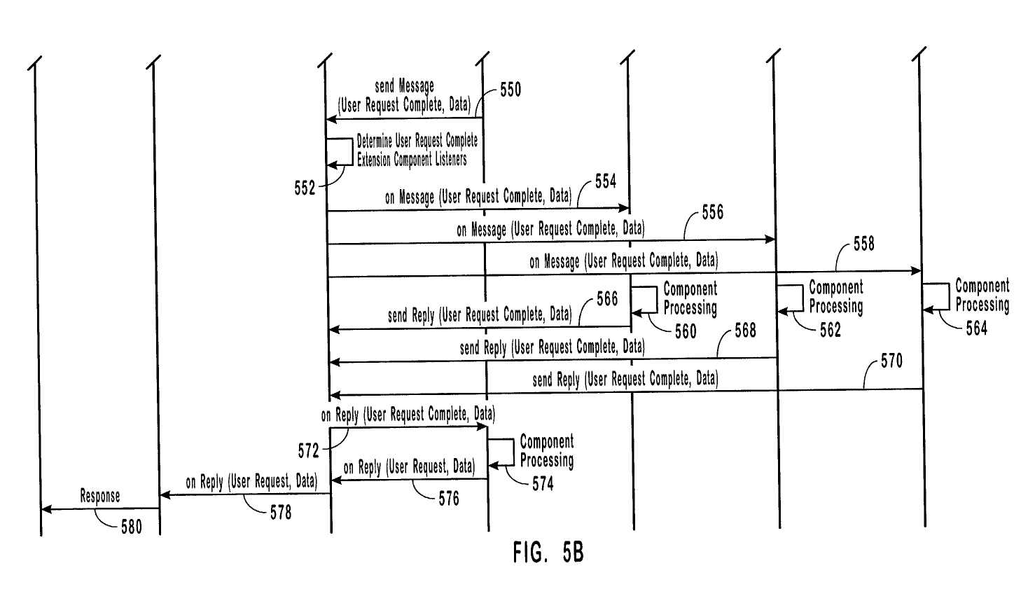

Follow-up or continued processing within original request processing component 312 is then undertaken in alternate processing request status processing module 332. Execution of alternate processing request status processing 332 uniquely depends upon the specific status or reply received from request processing extension component 322. Original request processing component 312 is originally programmed with alternative processing which depends upon the various allowable responses. In the present example, various gradients of responses (e.g., “A”, “B”, “C”, “D”, “E”, “F”, or “Yes”, “No”), are acceptable and are a function of the extensive alternative branching that is desirable for the specific application. In the examples of FIGS. 5-7, responses include “Yes”, “No”, and “Fatal No”. Following the alternate processing of module 332, original request processing component 312 issues a component-to-inter-component-messaging-service message 334 with an accompanying status or other reply message for delivery in a message 336 to originating client 300.

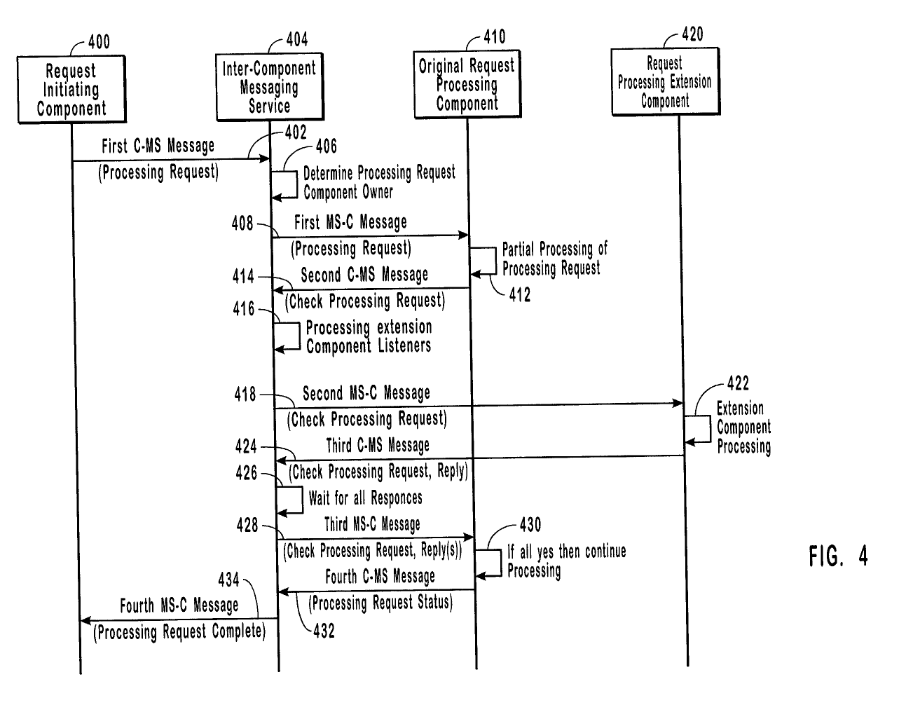

FIG. 4 is a flow diagram of various components interacting with the messaging service, in accordance with the preferred embodiment of the present invention. In FIG. 4, a request-initiating component 400 issues a processing request, either at the initiation of a user interacting with a client or at the initiation of another processing request from yet another component. Request initiating component 400 issues a processing request within a messaging protocol, depicted in FIG. 4, as a first component-to-inter-component-messaging-service message 402, which is sent to the inter-component messaging service 404 for processing.

Inter-component messaging service 404, in a step 406, consults a list, look up table or other database to determine the owner of a specific component designated by the processing request. Upon such a determination, inter-component messaging service 404 issues, to the designated owner of the processing request which in FIG. 4 is designated as original request processing component 410, a first inter-component-messaging-service-to-component message 408 having the processing request therein.

Original request processing component 410, upon the receipt of the processing request in step 408, performs partial processing, in step 412, of the processing request which includes, at a minimum, the generation of a check processing request included within a second component-to-inter-component-messaging-service message 414. Message 414 is sent to the inter-component messaging service 404 for evaluation. The check processing request inquiry generated by the original request processing component 410 facilitates the ability to accommodate the extensibility of software with other extension components that may register as concerned listeners with the inter-component messaging service 404. These extension components provide new functionality to the application based upon the responses generated by the execution of the extension modules as evaluated by the original request processing component. In a step 416, inter-component messaging service 404 consults a list or other database to determine the presence of request processing extension components that are registered with inter-component messaging service 404 as listeners.

Once the request processing extension component or plurality of extension components have been identified, inter-component messaging service 404 initiates a second inter-component-messaging-service-to-component message 418 having the check processing request therein to each of the identified request processing extension components 420. Request processing extension component 420 performs the respective extension component processing 422 and generates a corresponding reply. In a third component-to-inter-component-messaging-service message 424, request processing extension component 420 generates a message compatible with the inter-component-messaging service and embeds the check processing request as originally received therein as well as a reply generated in response to the extension component processing 422.

Inter-component messaging service 404 in a step 426 accumulates or gathers the replies from each of the request processing extension components as determined above. Once all replies have been received, inter-component messaging service 404 generates and delivers, to original request processing component 410, a third inter-component-messaging-service-to-component message 428 which includes the check processing request as well as an accumulation of the various replies received from the request processing extension component(s).

In a processing step 430, original request processing component 410 evaluates each of the replies and determines what actions to take. If the various replies are favorable, that is to say that the original request processing component 410 may resume its processing, then such processing is completed and upon such completion, original request processing component 410 generates a fourth component-to-inter-component-messaging-service message 432 which includes the original processing request and status generated by the original request processing component 410. Message 432 is delivered to inter-component messaging service 404 whereupon inter-component messaging service 404 generates a fourth inter-component-messaging-service-to-component message 434 having the processing request therein as well as informing request initiating component 400 of the completion of the processing request originally initiated above in step 402.

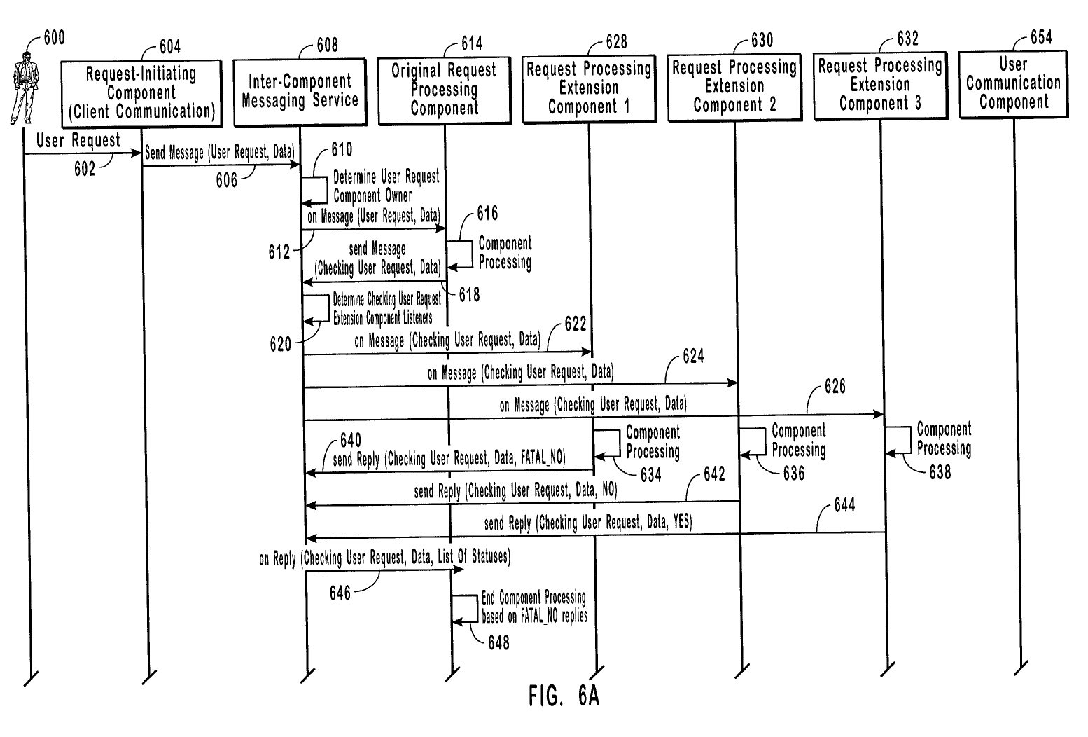

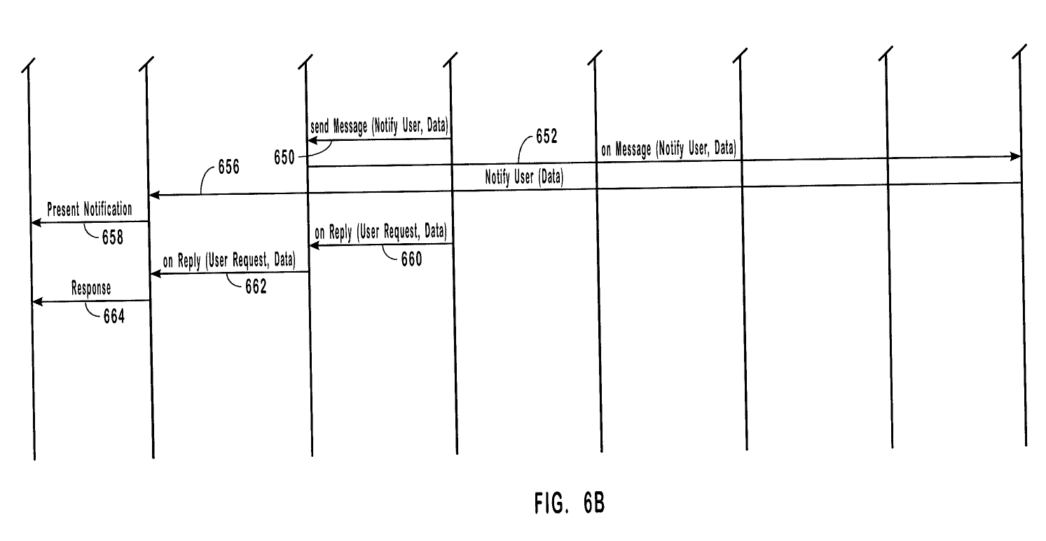

FIGS. 5, 6 and 7 are detailed flow diagrams of an exemplary embodiment of the present invention wherein the request processing extension components, in each of the Figures, respond with diverse replies from their individual extension component processing. The examples depicted in FIGS. 5, 6 and 7 illustrate the preferred embodiment wherein an exemplary multiple number of extension components, namely three, are registered as listeners and individually respond accordingly. Generally, in FIG. 5, request processing extension components unanimously reply with “yes” or favorable responses which inform the original request processing component to resume its inherent processing in totality as programmed within the original application. In contrast, the example of FIG. 6 depicts one of the request processing extension components as generating a “fatal no” reply which informs the original request processing component that another processing branch within the original request processing component must be traversed.

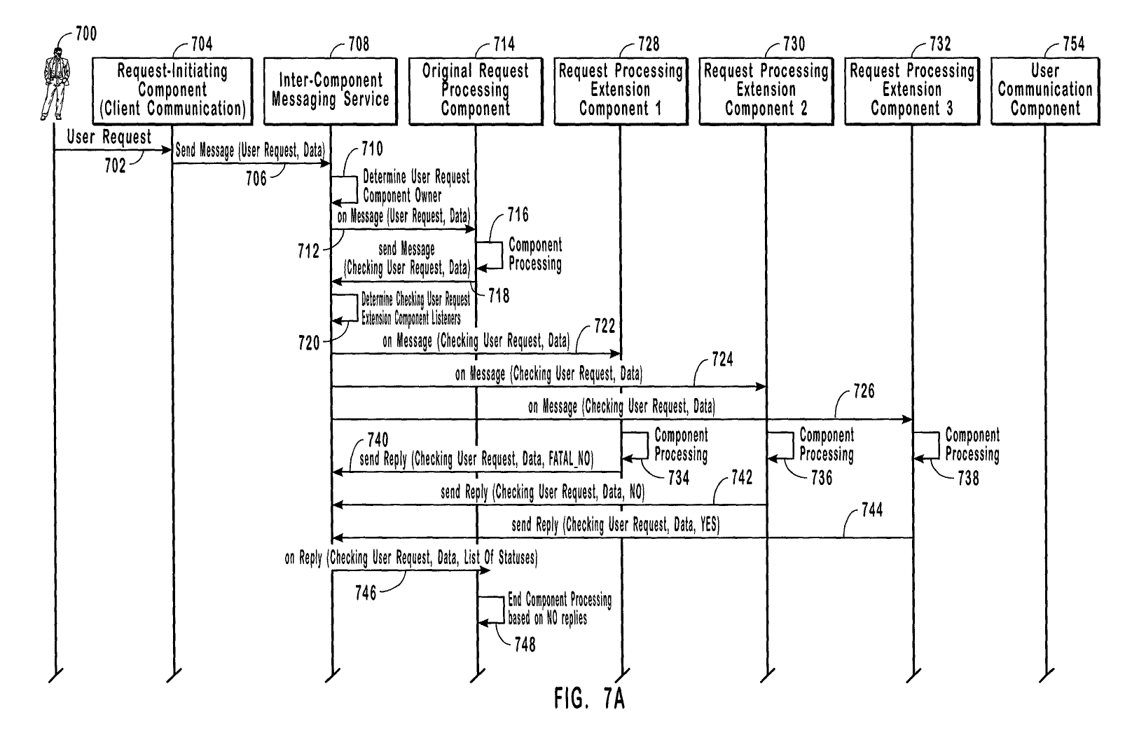

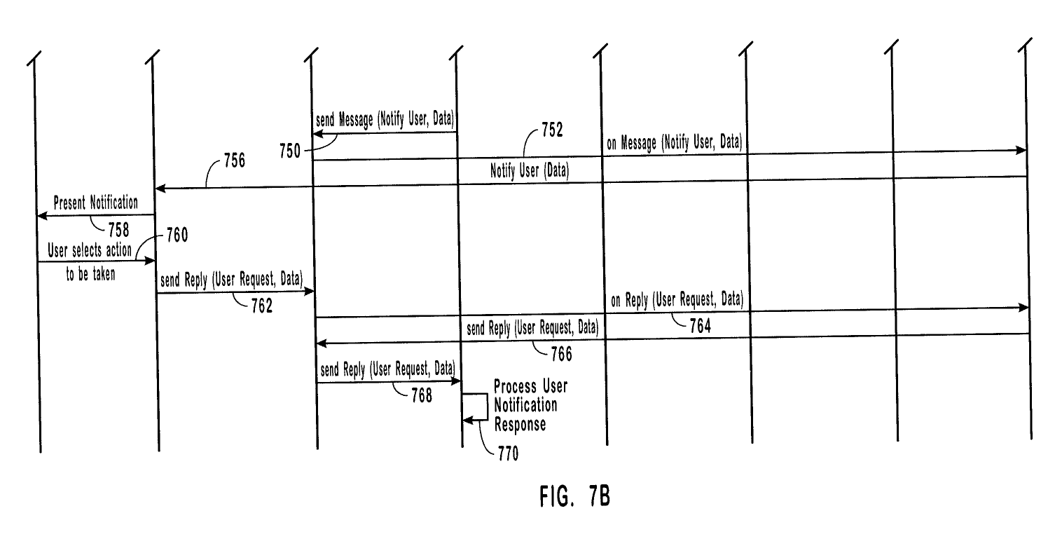

In FIG. 7, yet another gradient of reply is depicted as being at least one “no” reply, without a “fatal no” reply, from at least one of the request processing extension components. In the FIG. 7 example, the original request processing component traverses yet another response path as redirected by the extension modules. It should also be pointed out that FIGS. 5, 6 and 7 while including specific example responses, (namely “yes”, “no”, and “fatal no”) also include further refined specific message types both generated and received by the inter-component messaging service rather than the above-generalized “inter-component-messaging-service-to-component message” and the “component-to-inter-component-messaging-service message” of the above-referenced simplified flow diagrams. Such specifics are for illustrative purposes only and are not to be considered limiting of the scope of the present invention.

As described above, FIG. 5 details the messaging flow diagram of an exemplary embodiment of the present invention. In FIG. 5, a user 500 initiates an action with the system by initiating a user request 502 to a request initiating component, exemplary depicted herein as a client communication service or component 504, which provides servicing and interaction between user activated hardware equipment. For the sake of clarity, the previous figures and description referred to the initiating request generally as a “processing request” while the present specific examples refer to the initiating request as a “user request” as the request is initiated by a user at a client device. Request-initiating component 504 prepares a component-to-messaging service message, hereinafter “message”, 506, which embodies the users request for processing as well as any other data information.

Message 506 is received or directed to an inter-component messaging service 508 which is a messaging broker for all interaction between various components. Inter-component messaging service 508 determines, in a step 510, the owner or component to which the user request is directed. Such a determination, as described above, may take the form of a list look up or other database accessing techniques known and appreciated by those skilled in the art.

Inter-component messaging service 508 initiates an inter-component-messaging-service-to-component message, hereinafter “message”, 512, which includes the user request for processing as well as any other data originating from the request-initiating component 504. Message 512 is received by the original request processing 514, which performs component processing 516 in accordance with the original process. The original processing within original request processing component 514 includes a partitioning of the processing such that a first portion is performed which may be relatively simple or significantly sophisticated but, nevertheless, the original component processing includes a module or portion of the code that initiates a checking user request message 518 back to the inter-component messaging service 508 which requests that inter-component messaging service 508 determine any and all extension components that have registered as listeners for the user request. Such determination is illustrated in FIG. 5 as step 520. The registered extension component listeners may be stored in a list or other type of database as is accessible by inter-component messaging service 508.

Upon the determination of one or more extension components as registered listeners, inter-component messaging service 508 in steps 522, 524 and 526 initiate messages including the checking user or processing request, as well as any other data, to each of the respective request processing extension components, illustrated in FIG. 5 as request processing extension component 528, 530 and 532, respectively.

Each of the corresponding request processing extension components performs their inherent component processing steps illustrated in FIG. 5 as component processing 534, 536 and 538. It should be appreciated that the respective component processing inherent in the extension components allows for the extensibility of the software in that the original software components have not been altered but rather extension components have been registered with the original software application with the alternate or extensible processing taking place in the extension components.

In response to the extension component processing of 534, 536 and 538, request processing components 528, 530 and 532 generate respective reply messages 540, 542 and 544 which contain not only the matching check user or processing request as well as originating data but more importantly contain a reply which evaluates and may re-direct processing within the original application. The reply messages 540, 542 and 544 are received at inter-component messaging service 508 which initiates a message 546 back to original request processing component 514 and includes a summary or listing of various replies or status obtained from the individual extension components. Upon receipt of such a list of extension component responses, original request processing component 514, in step 548, continues or resumes the component processing inherent within the original request processing component 514 and alters such components processing based upon the replies or status received. In the present example, each of the replies from the extension components has been in the affirmative and original request processing proceeds accordingly.

Original request processing component 514, upon the completion of the continued component processing, generates a message 550 signifying the completion of the user request or processing. The message is directed to inter-component messaging service 508, which thereafter consults a list or database to determine the component listeners having an interest in the user request complete status. Such a determination is performed in step 552 where upon any registered listeners are thereafter consulted. In FIG. 5, messages 554, 556 and 558, including the user request or processing complete call, are directed to their respective extension components, illustrated for simplicity herein as the same originating components 528, 530 and 532. The respective processing continues in each of those modules in response to the user request complete. Such component processing is illustrated as component processing 560, 562 and 564. Following the completion of the extension component processing steps, each of the extension components generates a user request complete message 566, 568 and 570, which are handled by inter-component messaging service 508.

Thereafter, in response to the user request complete, inter-component messaging service 508 generates a user request complete message 572 to original request processing component 514. Original request processing component 514 performs component processing 574 which facilitates the completion of original request processing in the original application whereupon original request processing component 514 generates a reply to the user request in message 576 which is then forwarded back to request initiating component 504 in a reply message 578 which further results in a response 580 back to the user 500.

As described above, FIG. 6 details the messaging flow diagram of an exemplary embodiment of the present invention. In FIG. 6, a user 600 initiates an action with the system by initiating a user request 602 to a request initiating component, exemplary depicted herein as a client communication service or component 604, which provides servicing and interaction between user activated hardware equipment. Request-initiating component 604 prepares a message 606, which embodies the users request for processing as well as any other data information.

Message 606 is received or directed to an inter-component messaging service 608 which is a messaging broker for all interaction between various components. Inter-component messaging service 608 determines, in a step 610, the owner or component to which the user request is directed. Such a determination, as described above, may take the form of a list look up or other database accessing techniques known and appreciated by those skilled in the art.

Inter-component messaging service 608 initiates an inter-component-messaging-service-to-component message, hereinafter “message”, 612, which includes the user request for processing as well as any other data originating from the request-initiating component 604. Message 612 is received by the original request processing 614, which performs component processing 616 in accordance with the original process. The original processing within original request processing component 614 includes a partitioning of the processing such that a first portion is performed which may be relatively simple or significantly sophisticated but, nevertheless, the original component processing includes a module or portion of the code that initiates a checking user request message 618 back to the inter-component messaging service 608 which requests that inter-component messaging service 608 determine any and all extension components that have registered as listeners for the user request. Such determination is illustrated in FIG. 6 as step 620. The registered extension component listeners may be stored in a list or other type of database as is accessible by inter-component messaging service 608.

Upon the determination of one or more extension components as registered listeners, inter-component messaging service 608 in steps 622, 624 and 626 initiate messages including the checking user or processing request, as well as any other data, to each of the respective request processing extension components, illustrated in FIG. 6 as request processing extension component 628, 630 and 632, respectively.

Each of the corresponding request processing extension components performs their inherent component processing steps illustrated in FIG. 6 as component processing 634, 636 and 638. It should be appreciated that the respective component processing inherent in the extension components allows for the extensibility of the software in that the original software components have not been altered but rather extension components have been registered with the original software application with the alternate or extensible processing taking place in the extension components.

In response to the extension component processing of 634, 636 and 638, request processing components 628, 630 and 632 generate respective reply messages 640, 642 and 644 which contain not only the matching check user or processing request as well as originating data but more importantly contain a reply which evaluates and may re-direct processing within the original application. The reply messages 640, 642 and 644 are received at inter-component messaging service 608 which initiates a message 646 back to original request processing component 614 and includes a summary or listing of various replies or status obtained from the individual extension components. Upon receipt of the list of extension component responses, original request processing component 614, in step 648, continues or resumes the component processing inherent within the original request processing component 614 and alters such components processing based upon the replies or status received. In the present example, the illustrative and exemplary replies from the extension components are diverse and include responses defined to include “Yes”, “No” and “Fatal No”. In the present example, the “Fatal No” response signifies the no additional processing in the original request processing component 614 should proceed.

Original request processing component 614, upon the abandonment of the continued component processing, generates a message 650 signifying the termination of the user request or processing and requesting notification of the user that processing could not continue. The message is directed to inter-component messaging service 608, which thereafter consults the list for the component owner of the notification request and sends a notify user message 652 from the message service 608 to a user communication component 654. User communication component 654 then interacts with a call to the request initiating component 604 for presentation to the user over the client equipment in a step 658.

The originating user request 606 was responded to using message 660 generated by the original request processing component 614 as further forwarded by messaging service 608 in a message 662 to request initiating component 604 and as further presented to user 600 as a response 664.

As described above, FIG. 7 details the messaging flow diagram of an exemplary embodiment of the present invention. In FIG. 7, a user 700 initiates an action with the system by initiating a user request 702 to a request initiating component, exemplary depicted herein as a client communication service or component 704, which provides servicing, or interaction between user activated hardware equipment. Request-initiating component 704 prepares a message 706, which embodies the users request for processing as well as any other data information.

Message 706 is received or directed to an inter-component messaging service 708, which is a messaging broker for all interaction between various components. Inter-component messaging service 708 determines, in a step 710, the owner or component to which the user request is directed. Such a determination may take the form of a list look up or other database accessing techniques known and appreciated by those skilled in the art.

Inter-component messaging service 708 initiates an inter-component-messaging-service-to-component message, hereinafter “message”, 712, which includes the user request for processing as well as any other data originating from the request-initiating component 704. Message 712 is received by the original request processing 714, which performs component processing 716 in accordance with the original process. The original processing within original request processing component 714 includes a partitioning of the processing such that a first portion is performed which may be relatively simple or significantly sophisticated but, nevertheless, the original component processing includes a module or portion of the code that initiates a checking user request message 718 back to the inter-component messaging service 708 which requests inter-component messaging service 708 to determine any and all extension components that have registered as listeners for the user request. Such determination is illustrated in FIG. 7 as step 720. The registered extension component listeners may be stored in a list or other type of database as is accessible by inter-component messaging service 708.

Upon the determination of one or more extension components as registered listeners, inter-component messaging service 708 in steps 722, 724 and 726 initiate messages including the checking user or processing request, as well as any other data, to each of the respective request processing extension components, illustrated in FIG. 7 as request processing extension component 728, 730 and 732, respectively.

Each of the corresponding request processing extension components performs their inherent component processing steps illustrated in FIG. 7 as component processing 734, 736 and 738. It should be appreciated that the respective component processing inherent in the extension components allows for the extensibility of the software in that the original software components have not been altered but rather extension components have been registered with the original software application with the alternate or extensible processing taking place in the extension components.

In response to the extension component processing of 734, 736 and 738, request processing components 728, 730 and 732 generate respective reply messages 740, 742 and 744 which contain not only the matching check user or processing request as well as originating data but more importantly contain a reply which may be evaluated and re-direct processing within the original application. The reply messages 740, 742 and 744 are received at inter-component messaging service 708, which initiates a message 746 back to original request processing component 714 and includes a summary or listing of various replies or status obtained from the individual extension components. Upon receipt of the list of extension component responses, original request processing component 714, in step 748, evaluates the responses and ends the component processing inherent within the original request processing component 714 based upon the replies or “no” status received. In the present example, the illustrative and exemplary replies from the extension components are diverse and include responses defined to include “no”, “no” and “yes”. In the present example, the “no” response signifies the no additional processing in the original request processing component 714 should proceed.

Original request processing component 714, upon the abandonment of the continued component processing, generates a message 750 signifying the termination of the user request or processing and requesting notification of the user that processing could not continue. The message is directed to inter-component messaging service 708, which thereafter consults the list for the component owner of the notification request and sends the notify user message 752 from the message service 708 to a user communication component 754. User communication component 754 then interacts with a call to the request initiating component 704 for presentation to the user over the client equipment in a step 758. The user 700 responds by selecting the option to pursue in a step 760 which is forwarded in a message 762 to the inter-component messaging service 708. Steps 764-770 are illustrated for completeness in servicing the user response.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes, which come within the meaning and range of equivalency of the claims, are to be embraced within their scope.

What is claimed is:

1. An extensible software system, comprising:
a. an inter-component messaging service for receiving a first component-to-inter-component-messaging-service message having a processing request therein from a request-initiating component;
b. an original request processing component determined by said inter-component messaging service as the owner of said processing request, said original request processing component for receiving a first inter-component-messaging-service-to-component message having said processing request therein, said original request processing component, in response to partial processing, generates a second component-to-inter-component-messaging-service message having a check processing request therein, said inter-component messaging service capable of receiving said check processing request; and
c. at least one request processing extension component identified by said inter-component messaging service as having registered with said inter-component messaging service as a listener having an issue with processing of said processing request by said original request processing component, said at least one request processing extension component receiving a second inter-component-messaging-service-to-component message having said check processing request therein, said at least one request processing extension component generating a third component-to-inter-component-messaging-service message having at least one reply from said at least one request processing extension component in response to processing of said check processing request, said original request processing component receiving said at least one reply in a third inter-component-messaging-service-to-component message and upon continuation of said partial processing at said original request processing component according to said at least one reply, said original request processing component generating a fourth component-to-inter-component-messaging-service message having a processing request status therein.

2. The extensible software system, as recited in claim 1, wherein said inter-component messaging service further comprises:
a. a list of owners of processing requests for determining said original request processing component as said owner of said processing request.

3. The extensible software system, as recited in claim 1, wherein said inter-component messaging service further comprises:
a. a list of said at least one request processing extension component corresponding to said processing request for providing extensible processing to said extensible system in response to said processing request.

4. The extensible software system, as recited in claim 1, wherein said inter-component messaging service generates said inter-component-messaging-service-to-component messages and receives said component-to-inter-component-messaging-service messages asynchronously.

5. The extensible software system, as recited in claim 1, wherein said original request processing component further includes a software means for:
a. partially processing said first inter-component messaging-service-to-component messaging having said processing request therein prior to generating said second component-to-inter-component-messaging-service message having a check processing request therein.

6. The extensible software system, as recited in claim 5, wherein said original request processing component comprises alternate processing request status processing responsive to said third inter-component-messaging-service-to-component message for said continuation of said partial processing of said original request when said at least one reply indicates termination of any additional processing at said original request processing component according to said at least one reply.

7. The extensible software system, as recited in claim 1, wherein said original request processing component and said at least one request processing extension component are located in a server and said processing request originates in a client.

8. A method for modifying an original software application comprised of original request processing components and an inter-component messaging service into a customized software application comprised of said original software application and request processing extension components, without altering said original software application, said method comprising the steps of:
a. registering at said inter-component messaging service at least one of said request processing extension components as a listener for at least one processing request directed to one of said original request processing components;
b. receiving a message having said processing request therein from a request-initiating component, said request-initiating component being one of said original request processing components;
c. said inter-component messaging service determining one of said original request processing components as the owner of said processing request;
d. said original request processing component receiving a message having said processing request therein, and said original request processing component generating a message having a check processing request therein, said inter-component messaging service receiving said check processing request;
e. identifying at said inter-component messaging service at least one of said request processing extension component registered with said inter-component messaging service as a listener having an issue with processing of said processing request by said original request processing component;
f. said at least one request processing extension component receiving a message having said check processing request therein and, in response to partial processing, generating a message having at least one reply from said at least one request processing extension component in response to processing of said check processing request;
g. said original request processing component receiving said at least one reply in a message and upon continuation of said partial processing at said original request processing component according to said at least one reply, said original request processing component generating a message having a processing request status therein which is further forwarded to said request initiating component.

9. The method, as recited in claim 8, wherein said method further comprises the step of:
a. defining in said inter-component messaging service a list of owners of processing requests for determining said original request processing component as said owner of said processing request.

10. The method as recited in claim 8, wherein said method further comprises the step of:
a. defining in said inter-component messaging service a list of said at least one request processing extension component corresponding to said processing request for providing extensible processing to said extensible system in response to said processing request.

11. The method, as recited in claim 8, wherein said method further comprises the step of:
a. generating and receiving said messages asynchronously.

12. The method, as recited in claim 8, wherein said method further comprises the step of:
a. partitioning request processing in said original request processing component into alternate processing request status processing responsive to said message for said continuation of said partial processing of said original request when said at least one reply indicates termination of any additional processing at said original request processing component according to said at least one reply.

13. A computer-readable medium having computer-readable instructions for a method for modifying an original software application comprised of original request processing components and an inter-component messaging service into a customized software application comprised of said original software application and request processing extension components, without altering said original software application, said computer-executable instructions for performing the steps of:
a. registering at said inter-component messaging service at least one of said request processing extension components as a listener for at least one processing request directed to one of said original request processing components;
b. receiving a message having said processing request therein from a request-initiating component, said request-initiating component being one of said original request processing components;
c. said inter-component messaging service determining one of said original request processing components as the owner of said processing request;
d. said original request processing component receiving a message having said processing request therein, and said original request processing component generating a message having a check processing request therein, said inter-component messaging service receiving said check processing request;
e. identifying at said inter-component messaging service at least one as of said request processing extension component registered with said inter-component messaging service as a listener having an issue with processing of said processing request by said original request processing component;
f. said at least one request processing extension component receiving a message having said check processing request therein and, in response to partial processing, generating a message having at least one reply from said at least one request processing extension component in response to processing of said check processing request;
g. said original request processing component receiving said at least one reply in a message and upon continuation of said partial processing at said original request processing component according to said at least one reply, said original request processing component generating a message having a processing request status therein which is further forwarded to said request initiating component.

14. The computer-readable medium, as recited in claim 13, having further computer-readable instructions for performing the step of:
a. defining in said inter-component messaging service a list of owners of processing requests for determining said original request processing component as said owner of said processing request.

15. The computer-readable medium, as recited in claim 13, having further computer-readable instructions for performing the step of:
a. defining in said inter-component messaging service a list of said at least one request processing extension component corresponding to said processing request for providing extensible processing to said extensible system in response to said processing request.

16. The computer-readable medium, as recited in claim 13, having further computer-readable instructions for performing the step of:
a. generating and receiving said messages asynchronously.

17. The computer-readable medium, as recited in claim 13, having further computer-readable instructions for performing the step of:
a. partitioning request processing in said original request processing component into alternate processing request status processing responsive to said message for said continuation of said partial processing of said original request when said at least one reply indicates termination of any additional processing at said original request processing component according to said at least one reply.
